(19) United States
(12) Patent Application Publication
(10) Pub. No.: US 2002/0164040 A1
(43) Pub. Date: Nov. 7, 2002

(54) Built-in micro-speaker for wireless communication device

(76) Inventor: Bill Yang, Taipei (TW)

Correspondence Address: J.C. Patents, Inc., 4 Venture, Suite 250, Irvine, CA, 92618, US

(21) Appl. No.: 09/849,140

(22) Filed: May 4, 2001

(51) Int. Cl. H04R 25/00; H04R 11/02

(52) U.S. Cl. 381/150; 381/412

(57) ABSTRACT

An integral micro-speaker having bi-directional dual magnetic field loops is provided. In general, the integral micro-speaker is incorporated into a wireless communication device such as a wireless telephone or a mobile telephone. The integral micro-speaker serves as a receiver and a speaker in a wireless telephone. The integral micro-speaker may further incorporate a vibrator for producing an added vibration function to the wireless telephone. In other words, a receiver, a speaker and a vibrator may be combined together to form an integral component inside the wireless telephone.

### CROSS REFERENCE TO RELATED APPLICATION

This application claims the priority benefit of U.S.A. provisional application serial no. not assigned, filed Feb. 23, 2001.

### BACKGROUND OF THE INVENTION

1. Field of Invention

The present invention relates to a micro-speaker for a wireless communication device. More particularly, the present invention relates to a bi-directional dual magnetic field loop integral micro-speaker built in a communication device.

2. Description of the Related Art

Wireless communication devices such as wireless telephones or mobile telephones are necessary electrical devices for modern people. Especially, the mobile telephones become most popular communication devices around the world. Many communication manufacturing companies all focus on the development of the mobile telephones. Not only focus on providing more and more functions, but also focus on reducing costs for manufacturing the same.

Generally, when a mobile telephone receives electromagnetic waves, the mobile telephone will convert the waves into electrical signals. By using a speaker, the electrical signals are converted into voices, which are desired to transmitting to the user. The mobile telephone also uses another speaker acting as a receiver. When the user of the mobile telephone tries to talk with someone using another mobile telephone, the user's voice will be converted into electrical signals by the speaker. The electrical signals will then be converted into electromagnetic waves and transmitted to the someone's mobile telephone. By this way, the users can communicate to each other.

In addition, a further function of vibration is introduced in new mobile telephones and become more and more popular. When the user receives a phone call from another user, the vibration function will cause the mobile telephone vibrates to let user know a phone call is coming.

However, for providing all of these receiving, transmitting and vibrating functions, the mobile telephone needs two speakers and one vibrating device, which increases costs for manufacturing. Furthermore, because now the mobile telephones are required to be smaller than before, for installation of these three separate components, the print circuit board needs more space, which is not accepted by the requirement of the smaller mobile telephone.

### SUMMARY OF THE INVENTION

Therefore, in order to overcome the disadvantages of the conventional apparatus, the invention provides an integral micro-speaker having bidirectional dual magnetic field loops, which is incorporated into a wireless communication device such as a wireless telephone or a mobile telephone. The integral micro-speaker serves as a receiver and a speaker in a wireless telephone. The integral micro-speaker may further incorporate a vibrator for producing an added vibration function to the wireless telephone. In other words, a receiver, a speaker and a vibrator may be combined together to form an integral component inside the wireless telephone.

To achieve these and other advantages and in accordance with the purpose of the invention, as embodied and broadly described herein, the invention provides a wireless communication device built-in micro-speaker. The micro-speaker including a supporting device, a first vibration system and a second vibration system. The first vibration system has a first pole plate, a first magnetic iron core, a first acoustic coil and a first vibration membrane. The second vibration system has a second pole plate, a second magnetic iron core, a second acoustic coil and a second vibration membrane. The supporting device is interleaved between the first vibration system and the second vibration system. The second vibration system serves as a receiver of the wireless communication device, the first vibration system serves as a broadcasting speaker of the wireless communication device. For some case, the first vibration system and the second vibration system can be integrally formed in combination.

In the above-mentioned built-in micro-speaker, when the first vibration system serves as the broadcasting speaker of the wireless communication device, the first vibration system also serves as a vibration alarm producer and producing alarm vibration when receive a specified frequency signal.

In the above-mentioned built-in micro-speaker, the frequency of the specified frequency signal is ranged from 90 to 110 Hz, and 100 Hz is preferred.

In the above-mentioned built-in micro-speaker, the supporting device is a yoke-like device.

The above-mentioned built-in micro-speaker further comprises a connecting device for plugging into an external device for electrically coupling the external device.

The above-mentioned built-in micro-speaker further comprises a resonance mask for covering and protecting the second vibration system. The resonance mask further comprises a plurality of holes thereon for producing a resonance. The number of the holes on the resonance mask depends on a desired resonance frequency. The size of the hole on the resonance mask depends on a desired resonance frequency.

To achieve these and other advantages and in accordance with the purpose of the invention, as embodied and broadly described herein, the invention provides a built-in micro-speaker for a wireless communication device. The micro-speaker includes a supporting device, a first vibration system and a second vibration system. The first vibration system has a first pole plate, a first magnetic iron core, a first acoustic coil and a first vibration membrane. The second vibration system has a second pole plate, a second magnetic iron core, a second acoustic coil and a second vibration membrane. The first vibration membrane is heavier than the second vibration membrane. The supporting device is interleaved between the first vibration system and the second vibration system. The first vibration system and the second vibration system are integrally formed in combination. The second vibration system serves as a receiver of the wireless communication device and the first vibration system serves as a broadcasting speaker of the wireless communication device.

In the above-mentioned built-in micro-speaker, when the first vibration system serves as the broadcasting speaker of the wireless communication device, the first vibration system also serving as a vibration alarm producer and producing alarm vibration when receive a specified frequency signal.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIGS. 1A through 1C are the respective top view, cross-sectional side view and bottom view of an integral micro-speaker fabricated according to this invention;

FIG. 2 is a detailed cross-sectional side view of the integral micro-speaker 105 as shown in FIG. 1B; and

FIGS. 3A and 3B are schematic diagrams showing the dual magnet loops and the electrical coiling around magnetic irons inside the micro-speaker of this invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

This invention is related to a type of integral micro-speaker having bi-directional dual magnetic field loops. In general, the integral micro-speaker is incorporated into a wireless communication device such as a wireless telephone or a mobile telephone. The integral micro-speaker serves as a receiver and a speaker in a wireless telephone. The integral micro-speaker may further incorporate a vibrator for producing an added vibration function to the wireless telephone. In other words, a receiver, a speaker and a vibrator may be combined together to form an integral component inside the wireless telephone.

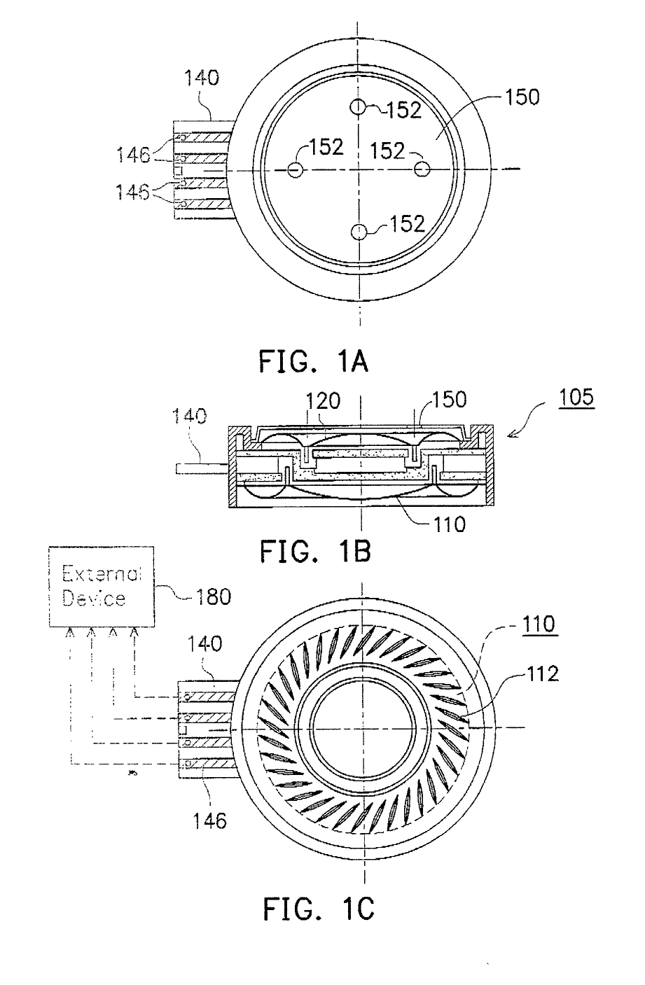

FIGS. 1A through 1C are the respective top view, cross-sectional side view and bottom view of an integral micro-speaker fabricated according to this invention. As shown in FIG. 1B, the integral micro-speaker 105 includes two vibration systems: a first vibration system 110 and a second vibration system 120. Both vibration systems 110 and 120 have a magnetic field loop. Each magnetic field loop includes an inner magnetic pole plate, an outer magnetic pole plate and a magnetic iron core. Each of vibration systems 110 and 120 further includes an acoustic coil and a vibration membrane. The following is a more detailed description of the internal components of the integral micro-speaker according to this invention.

The integral micro-speaker 105 has a connecting device 140 for plugging into an external device such as a wireless telephone so that electrical signal can travel into and out of the integral micro-speaker 105. The connecting device includes a number of contact fingers such as the lines 146 shown in FIGS. 1A and 1C for transmitting signals.

In addition, the integral micro-speaker 105 further includes a resonance mask 150 for protecting the receiver. The resonance mask 150 may contain a plurality of holes thereon (four holes are shown in FIG. 1C) for producing a resonance. The number of holes bored on the resonance mask 150 depends on the resonance frequency desired. Radius of these holes may also be changed to increase resonance effects. In other words, the number of holes and size of the holes on the resonance mask 150 can be considered individually or together.

Since both the vibration systems 110 and 120 can serve as a receiver or a speaker for the integral micro-speaker 105, one of the vibration systems may serve as a receiver while the other may serve as a speaker. For example, if the vibration system 110 serves as a receiver, the vibration system 120 will serve as a speaker. When the vibration system 110 serves as a receiver, a wireless communication device such as a wireless telephone may use the vibration system 110 to convert acoustic vibration into electrical signals. The electrical signal is sent through a cable to a user at the other end of the line or to a wireless network before going to a user connected to the network. The vibration system 120, which now serves as a speaker inside the wireless communication device such as a wireless telephone, receives the acoustic-turned-electrical signals from the other user through a telephone cable or a network and converts to acoustic vibration. One major aspect of the integral micro-speaker 105 is the inclusion of two vibration systems. Obviously, the vibration system 110 may serve as a broadcasting speaker so that the vibration system 120 now serves as a receiver. Since both types of arrangement are feasible in this invention, the scope of this invention is not limited by this.

Furthermore, the micro-speaker of invention may be converted into an integral speaker system capable of serving as a receiver, a broadcasting speaker and a vibration alarm is required. All that is required is to convert a specified frequency signal, such as in a range from 90 to 110 Hz and 105 Hz is preferred for a normal wireless telephone, into broadcasting vibration. In the preferred embodiment of this invention, the vibration system 110 may serve as such a vibration alarm producer. Because the vibration system 110 contains a heavier vibration membrane and a multitude of supporting rings 112 as shown in FIG. 1A, a better vibrating effect may be obtained if used as a vibrator for alarming a user.

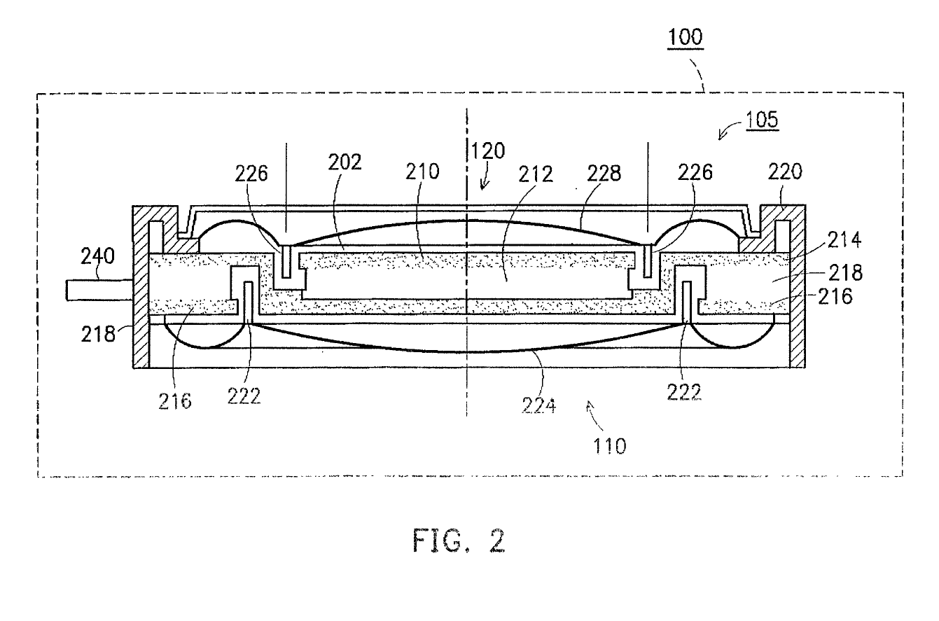

FIG. 2 is a detailed cross-sectional side view of the integral micro-speaker 105, as shown in FIG. 1B, built in a wireless communication device 100. As shown in FIG. 2, the integral micro-speaker 105 comprises of an iron pan 202, a pair of magnetic iron core 212 and 218, an inner pole plate 210, an outer pole plate 216. The iron pan, magnetic iron cores and pole plates together form the dual magnetic field loops required by this invention. For example, the magnetic iron core 212 and the inner pole plate 210 form an inner magnetic field loop. The magnetic iron core 218 and the inner pole plate 216 form an outer magnetic field loop. There is a supporting device such as a yoke-like device 214 interleaved between two magnetic field loops. In general, the components constituting the dual magnetic loop structure are embedded within a rubbery basic framework 220 to form an integral unit.

The vibration system of this micro-speaker 105 includes a pair of acoustic coils 222 and 226 and a pair of vibration membranes 224 and 228. For example, as shown in FIG. 2, the vibration system 110 comprises of the acoustic coil 222 and the vibration membrane 224. The other vibration system 120 comprises of the acoustic coil 226 and the vibration membrane 228. All these acoustic coils and vibration membranes are joined together forming an integral structure using rubber material.

The vibration system structures are placed over the aforementioned basic framework 220. The entire structure actually includes the rubber frame 220 with the respective vibration system structures glued onto the upper and lower surface of the rubber frame 220 respectively. The two independent magnetic field loops are connected to the connecting device 240 so that necessary signal can be transmitted to and from the respective vibration system.

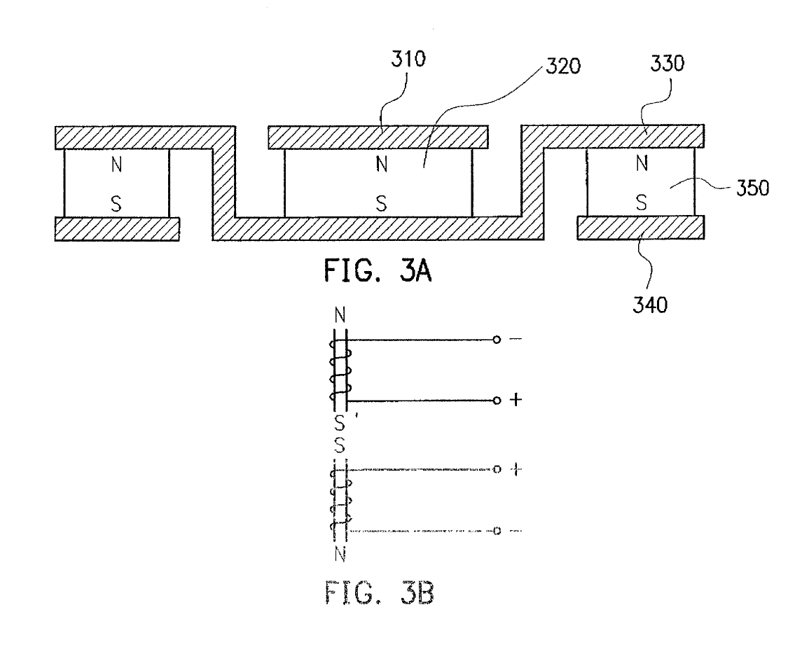

FIGS. 3A and 3B are schematic diagrams showing the dual magnet loops and the electrical coiling around magnetic irons inside the micro-speaker of this invention. The dual magnetic field loops are actually separate magnetic circuits. One magnetic circuit comprises of a magnetic iron 320 and a pole plate 310 at either end of the magnetic iron 320. The other magnetic circuit comprises of a magnetic iron 350 and a pole plates 340 at either end of the magnetic iron 350.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A built-in micro-speaker for a wireless communication device, the micro-speaker including:
a supporting device;
a first vibration system, having a first pole plate, a first magnetic iron core, a first acoustic coil and a first vibration membrane;
a second vibration system, having a second pole plate, a second magnetic iron core, a second acoustic coil and a second vibration membrane, wherein the supporting device is interleaved between the first vibration system and the second vibration system, wherein the second vibration system serves as a receiver of the wireless communication device, the first vibration system serves as a broadcasting speaker of the wireless communication device.

2. The built-in micro-speaker of claim 1, wherein when the first vibration system serves as the broadcasting speaker of the wireless communication device, the first vibration system also serving as a vibration alarm producer and producing alarm vibration when receive a specified frequency signal.

3. The built-in micro-speaker of claim 2, wherein the frequency of the specified frequency signal is ranged from 90 to 110 Hz.

4. The built-in micro-speaker of claim 3, wherein the frequency of the specified frequency signal is about 100 Hz.

5. The built-in micro-speaker of claim 1, wherein the supporting device is a yoke-like device.

6. The built-in micro-speaker of claim 1, further comprising a connecting device for plugging into an external device for electrically coupling the external device.

7. The built-in micro-speaker of claim 1, further comprising a resonance mask for covering and protecting the second vibration system.

8. The built-in micro-speaker of claim 7, the resonance mask further comprising a plurality of holes thereon for producing a resonance.

9. The built-in micro-speaker of claim 8, the number of the holes on the resonance mask depending on a desired resonance frequency.

10. The built-in micro-speaker of claim 8, the size of the hole on the resonance mask depending on a desired resonance frequency.

11. A built-in micro-speaker for a wireless communication device, the micro-speaker including:
a supporting device;
a first vibration system, having a first pole plate, a first magnetic iron core, a first acoustic coil and a first vibration membrane;
a second vibration system, having a second pole plate, a second magnetic iron core, a second acoustic coil and a second vibration membrane, wherein the supporting device is interleaved between the first vibration system and the second vibration system, wherein the first vibration system and the second vibration system are integrally formed, wherein the second vibration system serves as a receiver of the wireless communication device, the first vibration system serves as a broadcasting speaker of the wireless communication device.

12. The built-in micro-speaker of claim 11, wherein when the first vibration system serves as the broadcasting speaker of the wireless communication device, the first vibration system also serving as a vibration alarm producer and producing alarm vibration when receive a specified frequency signal.

13. The built-in micro-speaker of claim 12, wherein the frequency of the specified frequency signal is ranged from 90 to 110 Hz.

14. The built-in micro-speaker of claim 13, wherein the frequency of the specified frequency signal is about 100 Hz.

15. The built-in micro-speaker of claim 11, wherein the supporting device is a yoke-like device.

16. The built-in micro-speaker of claim 11, further comprising a connecting device for plugging into an external device for electrically coupling the external device.

17. The built-in micro-speaker of claim 11, further comprising a resonance mask for covering and protecting the second vibration system.

18. The built-in micro-speaker of claim 17, the resonance mask further comprising a plurality of holes thereon for producing a resonance.

19. The built-in micro-speaker of claim 18, the number of the holes on the resonance mask depending on a desired resonance frequency.

20. The built-in micro-speaker of claim 18, the size of the hole on the resonance mask depending on a desired resonance frequency.

21. A built-in micro-speaker for a wireless communication device, the micro-speaker including:
a supporting device;
a first vibration system, having a first pole plate, a first magnetic iron core, a first acoustic coil and a first vibration membrane;
a second vibration system, having a second pole plate, a second magnetic iron core, a second acoustic coil and a second vibration membrane, wherein the first vibration membrane is heavier than the second vibration membrane, the supporting device being interleaved between the first vibration system and the second vibration system, the first vibration system and the second vibration system being integrally formed, the second vibration system serving as a receiver of the wireless communication device, the first vibration system serving as a broadcasting speaker of the wireless communication device.

22. The built-in micro-speaker of claim 21, wherein when the first vibration system serves as the broadcasting speaker of the wireless communication device, the first vibration system also serving as a vibration alarm producer and producing alarm vibration when receive a specified frequency signal.

23. A wireless communication device, comprising a built-in micro-speaker, wherein the micro-speaker comprising:
a supporting device;
a first vibration system, having a first pole plate, a first magnetic iron core, a first acoustic coil and a first vibration membrane;
a second vibration system, having a second pole plate, a second magnetic iron core, a second acoustic coil and a second vibration membrane, wherein the supporting device is interleaved between the first vibration system and the second vibration system, wherein the first vibration system and the second vibration system are integrally formed, wherein the second vibration system serves as a receiver of the wireless communication device, the first vibration system serves as a broadcasting speaker of the wireless communication device.

24. The wireless communication device of claim 23, wherein when the first vibration system serves as the broadcasting speaker of the wireless communication device, the first vibration system also serving as a vibration alarm producer and producing alarm vibration when receive a specified frequency signal.

25. The wireless communication device of claim 24, wherein the frequency of the specified frequency signal is ranged from 90 to 110 Hz.

26. The wireless communication device of claim 25, wherein the frequency of the specified frequency signal is 100 Hz.

27. The wireless communication device of claim 23, wherein the supporting device is a yoke-like device.

28. The built-in micro-speaker of claim 23, further comprising a connecting device for plugging into an external device for electrically coupling the external device.

29. The wireless communication device of claim 23, further comprising a resonance mask for covering and protecting the second vibration system.

30. The wireless communication device of claim 29, the resonance mask further comprising a plurality of holes thereon for producing a resonance.

31. The wireless communication device of claim 30, the number of the holes on the resonance mask depending on a desired resonance frequency.

32. The wireless communication device of claim 31, the size of the hole on the resonance mask depending on a desired resonance frequency.
